(19) United States
(12) Patent Application Publication
(10) Pub. No.: US 2007/0268289 A1
(43) Pub. Date: Nov. 22, 2007

(54) Graphics system with dynamic reposition of depth engine

(76) Inventors: Chun Yu, San Diego, CA (US); Brian Ruttenberg, San Diego, CA (US); Guofang Jiao, San Diego, CA (US); Yun Du, San Diego, CA (US)

Correspondence Address: QUALCOMM INCORPORATED, 5775 MOREHOUSE DR., SAN DIEGO, CA, 92121, US

(21) Appl. No.: 11/435,454

(22) Filed: May 16, 2006

(51) Int. Cl. G06T 15/40

(52) U.S. Cl. 345/422

(57) ABSTRACT

A graphics system includes a graphics processor comprising a plurality of units configured to process a graphics image and a depth engine configured to receive and process data selected from one of two units based on a selection value.

### BACKGROUND

I. Field

The present disclosure relates generally to a graphics system, and more specifically to a graphics system with dynamic reposition of a depth engine.

II. Background

Graphics systems may render 2-dimensional (2-D) and 3-dimensional (3-D) images for various applications such as video games, graphics, computer-aided design (CAD), simulation and visualization tools, imaging, etc. A 3-D image may be modeled with surfaces. Each surface may be approximated with polygons, which are typically triangles. A number of triangles used to represent a 3-D image may depend on complexity of the surfaces and a desired resolution of the image. The number of triangles may be quite large, such as millions of triangles. Each triangle is defined by three vertices. Each vertex may be associated with various attributes such as space coordinates, color values, and texture coordinates. Each attribute may have three or four components. For example, space coordinates are typically given by horizontal (x), vertical (y) and depth (z) coordinates. Color values are typically given by red, green, and blue (r, g, b) values. Texture coordinates are typically given by horizontal and vertical coordinates (u and v).

A graphics processor in a graphics system may perform various graphics operations to render a 2-D or 3-D image. The image may be composed of many triangles, and each triangle is composed of picture elements, i.e., pixels. The graphics processor renders each triangle by determining component values of each pixel within the triangle. The graphics operations may include rasterization, texture mapping, shading, etc.

### SUMMARY

A graphics system may include a graphics processor with processing units that perform various graphics operations to render graphic images.

One aspect relates to an apparatus comprising: a plurality of units configured to process a graphics image; and a depth engine configured to receive and process data selected from one of two units based on a selection value.

Another aspect relates to a machine readable storage medium storing a set of instructions comprising: processing a graphics image using several graphics processing modules; and selectively switching data input to a depth engine from one of two units based on a selection value.

Another aspect relates to an apparatus comprising: a plurality of means for processing a graphics image; and a depth testing means for receiving and processing data selected from one of two units based on a selection value.

Another aspect relates to a method comprising: processing a graphics image using several graphics processing modules; receiving a selection value; and selectively switching data input to a depth engine from one of two units based on the selection value.

### BRIEF DESCRIPTION OF THE DRAWINGS

FIG. 1 illustrates a wireless communication device.

FIG. 2 illustrates components of a graphics processor within the wireless device of FIG. 1.

FIG. 3 illustrates another configuration of a graphics processor with two depth engines.

FIG. 4 illustrates another configuration of a graphics processor with a dynamic reposition of a depth engine.

### DETAILED DESCRIPTION

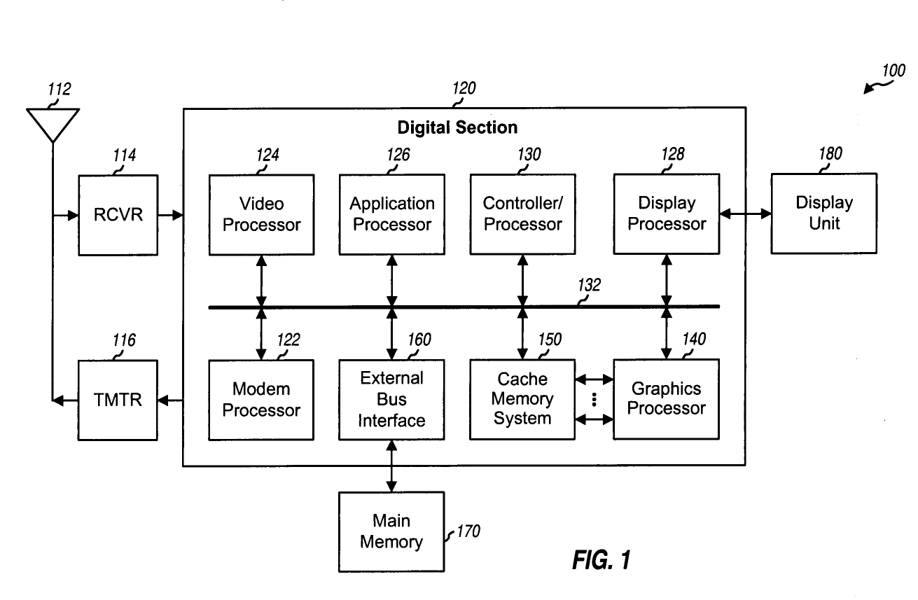

FIG. 1 illustrates a wireless communication device 100, which may be used in a wireless communication system. The device 100 may be a cellular phone, a terminal, a handset, a personal digital assistant (PDA), a laptop computer, a video game unit or some other device. The device 100 may use Code Division Multiple Access (CDMA), Time Division Multiple Access, such as Global System for Mobile Communications (GSM), or some other wireless communication standard.

The device 100 may provide bi-directional communication via a receive path and a transmit path. On the receive path, signals transmitted by one or more base stations may be received by an antenna 112 and provided to a receiver (RCVR) 114. The receiver 114 conditions and digitizes the received signal and provides samples to a digital section 120 for further processing. On the transmit path, a transmitter (TMTR) 116 receives data to be transmitted from the digital section 120, processes and conditions the data, and generates a modulated signal, which is transmitted via the antenna 112 to one or more base stations.

The digital section 120 may be implemented with one or more digital signal processors (DSPs), micro-processors, reduced instruction set computers (RISCs), etc. The digital section 120 may also be fabricated on one or more application specific integrated circuits (ASICs) or some other type of integrated circuits (ICs).

The digital section 120 may include various processing and interface units such as, for example, a modem processor 122, a video processor 124, an application processor 126, a display processor 128, a controller/processor 130, a graphics processor 140, and an external bus interface (EBI) 160.

The modem processor 122 performs processing for data transmission and reception, e.g., encoding, modulation, demodulation, and decoding. The video processor 124 may perform processing on video content (e.g., still images, moving videos, and moving texts) for video applications such as camcorder, video playback, and video conferencing. The application processor 126 performs processing for various applications such as multi-way calls, web browsing, media player, and user interface. The display processor 128 may perform processing to facilitate the display of videos, graphics, and texts on a display unit 180. The controller/processor 130 may direct the operation of various processing and interface units within the digital section 120.

A cache memory system 150 may store data and/or instructions for a graphics processor 140. The EBI 160 facilitates transfer of data between the digital section 120 (e.g., the caches) and the main memory 170.

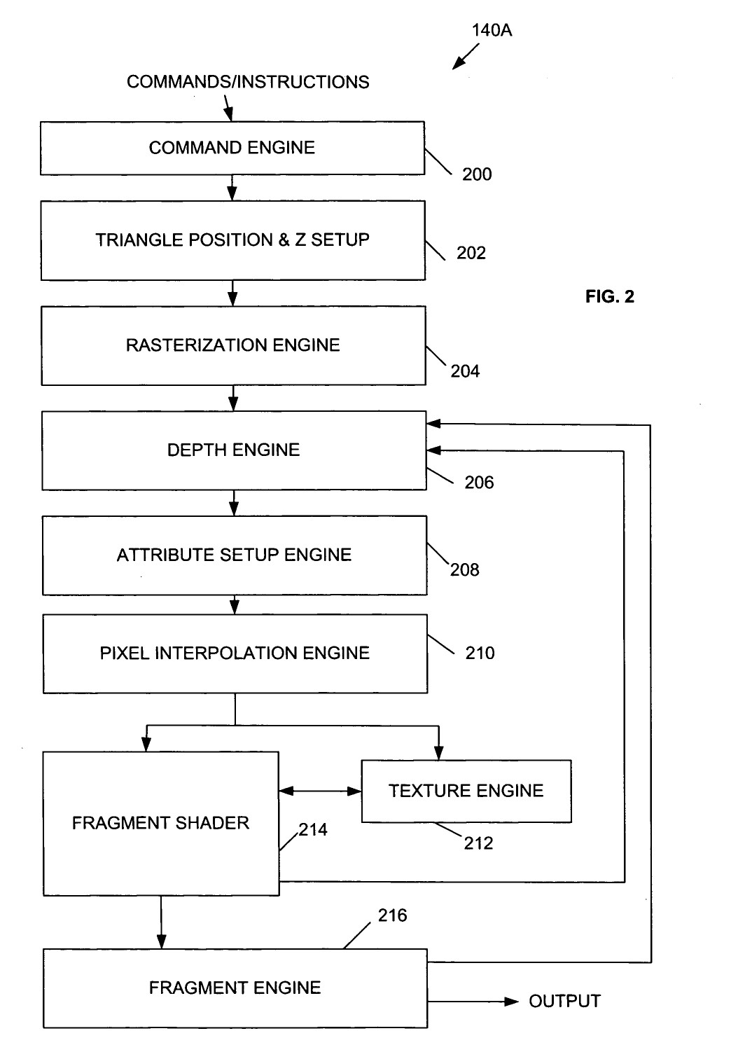

The graphics processor 140 may perform processing for graphics applications and may be implemented as described herein. In general, the graphics processor 140 may include any number of processing units or modules for any set of graphics operations. The graphics processor 140 and its components (described below with FIGS. 2-4) may be implemented in various hardware units, such as ASICs, digital signal processing device (DSPDs), programmable logic devices (PLDs), field programmable gate array (FPGAs), processors, controllers, micro-controllers, microprocessors, and other electronic units.

Certain portions of the graphics processor 140 may be implemented in firmware and/or software. For example, a control unit may be implemented with firmware and/or software modules (e.g., procedures, functions, and so on) that perform functions described herein. The firmware and/or software codes may be stored in a memory (e.g., memory 170 in FIG. 1) and executed by a processor (e.g., processor 130). The memory may be implemented within the processor or external to the processor.

The graphics processor 140 may implement a software interface such as Open Graphics Library (OpenGL), Direct3D, etc. OpenGL is described in a document entitled “The OpenGL® Graphics System: A Specification,” Version 2.0, dated Oct. 22, 2004, which is publicly available.

FIG. 2 illustrates some components or processing units of one configuration 140A of the graphics processor 140 within the wireless device 100 of FIG. 1. FIG. 2 may represent a front part of a GPU (Graphics Processing Unit). Each processing unit may be an engine that is implemented with dedicated hardware, a processor, or a combination of both. For example, the engines shown in FIG. 2 may be implemented with dedicated hardware, whereas the fragment shader 214 may be implemented with a programmable central processing unit (CPU) or built-in processor.

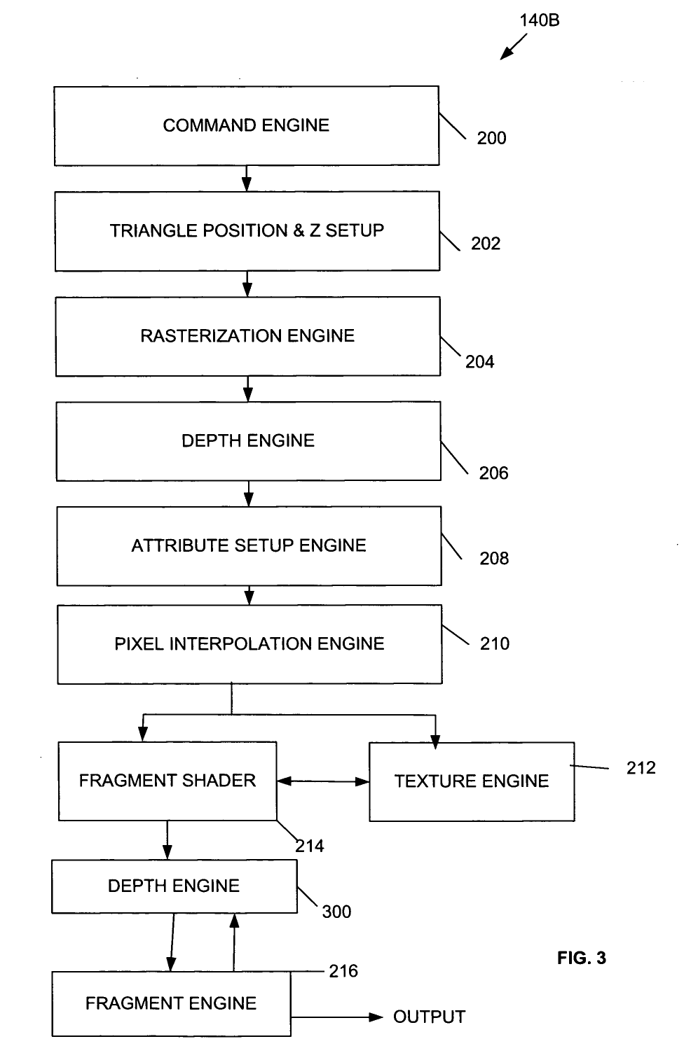

In other configurations, the processing units 200-216 may be arranged in various orders depending on desired optimizations. For example, to conserve power, it may be desirable to perform stencil and depth tests early in the pipeline so that pixels that are not visible are discarded early, as shown in FIG. 2. As another example, stencil and depth engine 206 may be located after texture mapping engine 212, as shown in FIG. 3.

In FIG. 2, the various processing units 200-216 arranged in a pipeline to render 2-D and 3D images. Other configurations of the graphics processor 140A may include other units instead of or in addition to the units shown in FIG. 2.

A command engine 200 may receive and decode incoming rendering commands or instructions that specify graphics operations to be performed. A triangle position and z setup engine 202 may compute necessary parameters for a subsequent rasterization process. For example, the triangle position and z setup engine 202 may compute coefficients of linear equations for the three edges of each triangle, coefficients for depth (z) gradient, etc. The triangle position and z setup engine 202 may be called a primitive setup, which does viewport transform and primitive assembly, primitive rejection against scissor window, and backface culling.

A rasterization engine 204 (or scan converter) may decompose each triangle or line into pixels and generate a screen coordinate for each pixel.

A depth engine 206 may perform a stencil test on each pixel to determine whether the pixel should be displayed or discarded. A stencil buffer may store a current stencil value for each pixel location in the image being rendered. The depth engine 206 may compare the stored stencil value for each pixel against a reference value and retain or discard the pixel (e.g., generate a pass or fail flag) based on the comparison.

The depth engine 206 may also perform a depth test (also called a z-test) on each pixel, if applicable, to determine whether the pixel should be displayed or discarded. A z-buffer stores the current z value for each pixel location in the image being rendered. The depth engine 206 may compare the z value of each pixel (the current z value) against a corresponding z value in the z-buffer (the stored z value), generate a pass or fail flag based on the comparison, display the pixel, and update the z-buffer and possibly the stencil buffer if the current z value is closer/nearer than the stored z value. The depth engine 206 may discard the pixel if the current z value is further back than the stored z value. This early depth/stencil test and operation may reject possible invisible pixels/primitives.

An attribute setup engine 208 may compute parameters for subsequent interpolation of pixel attributes. For example, attribute setup engine 208 may compute coefficients of linear equations for attribute interpolation. A pixel interpolation engine 210 may compute attribute component values for each pixel within each triangle based on the pixel's screen coordinate and use information from the attribute setup engine 208. The attribute setup engine 208 and pixel interpolation engine 210 may be combined in an attribute interpolator to interpolate over pixels of every visible primitive.

A texture mapping engine (or texture engine) 212 may perform texture mapping, if enabled, to apply texture to each triangle. A texture image may be stored in a texture buffer. The three vertices of each triangle may be associated with three (u, v) coordinates in the texture image, and each pixel of the triangle may then be associated with specific texture coordinates in the texture image. Texturing may be achieved by modifying the color of each pixel with the color of the texture image at the location indicated by that pixel's texture coordinates.

Each pixel is associated with information such as color, depth, texture, etc. A “fragment” is a pixel and its associated information. A fragment shader 214 may apply a software program comprising a sequence of instructions to each fragment. The fragment shader 214 may modify z values. The fragment shader 214 may generate a test on whether to discard a pixel and send the test result to the depth engine 206. The fragment shader 214 may also send texture requests to the texture mapping engine 212.

A fragment engine 216 may finish final pixel rendering and perform functions such as an alpha test (if enabled), fog blending, alpha blending, logic operation, and dithering operation on each fragment and provide results to a color buffer. If the alpha test is enabled, the fragment engine 216 may send results of the alpha test to the depth engine 206, which may determine whether to display a pixel.

Performing a depth test at early stage as in FIG. 2 may save power and bandwidth. The graphics processor 140A does not need to waste computation power and memory bandwidth to perform attribute setup, pixel interpolation, texture fetching and applying shader programs on those invisible pixels.

However, some shader programs modify depth value. FIG. 3 illustrates a graphics processor 140B that performs a depth test 300 after the fragment shader 214 and disables the early depth engine 206. Having two identical depth engines 206, 300 in the pipeline builds redundancy in the design, which is not good for power and microchip area.

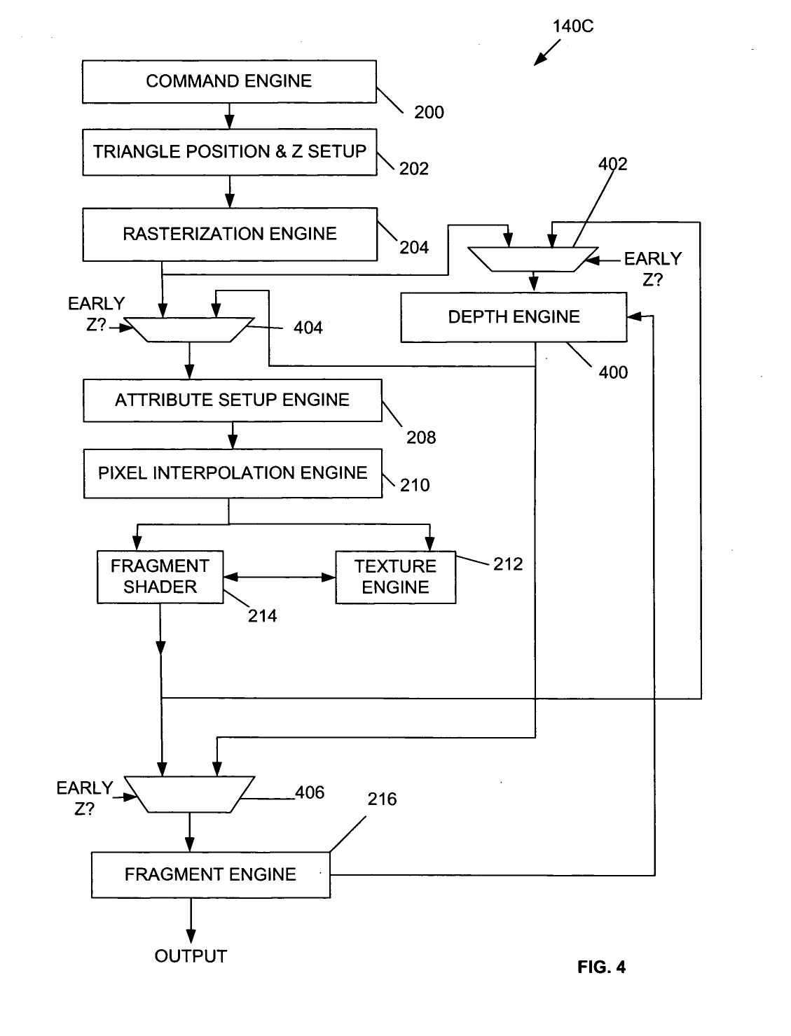

FIG. 4 illustrates a solution to this problem by designing a graphics processor 140C with one depth engine 400, which can be switched or repositioned dynamically to early Z test position or post shader based on a graphics application. The graphics application can do either an early depth (z) test or a later depth test after shader z-value modification. Software in the graphics processor 140C or digital section 120 may know a shader program in advance.

An “early z” input in FIG. 4 may be a one-bit, binary value (1 or 0) to indicate early z or not early z. If “early z” is selected, a first multiplexer 402 passes data from the rasterization engine 204 to the depth engine 400, and a second multiplexer 404 passes data from the depth engine 400 to the attribute setup engine 208. Multiplexers 402, 404 and 406 in FIG. 4 may be implemented by other components such as switches, etc.

If “early z” is not selected, the second multiplexer 404 passes data from the rasterization engine 204 to the attribute setup engine 208, and the first multiplexer 402 passes data from the fragment shader 214 to the depth engine 400. A third multiplexer 406 may pass data from the depth engine 400 to another component, such as a fragment engine 216.

The graphics processor 140C in FIG. 4 has the flexibility of supporting both early Z and shader-modified Z case. The graphics processor 140C saves the need of building two identical depth engines, compared to FIG. 3.

The graphics systems described herein may be used for wireless communication, computing, networking, personal electronics, etc. Various modifications to the embodiments described above will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An apparatus comprising:
a plurality of units configured to process a graphics image; and
a depth engine configured to receive and process data selected from one of two units based on a selection value.

2. The apparatus of claim 1, wherein the depth engine is configured to perform a stencil test on each pixel to determine whether to discard the pixel, the stencil test comprising comparing a stored stencil value for each pixel against a reference value.

3. The apparatus of claim 1, wherein the depth engine is configured to receive at least one of an alpha test result and a fragment shader test result, perform a stencil test on each pixel, and determine whether to display the pixel.

4. The apparatus of claim 1, wherein the depth engine is configured to perform a depth test on each pixel to determine whether to discard the pixel, the depth test comprising comparing a current z value of each pixel against a corresponding stored z value in a buffer and determine whether to discard the pixel based on the comparison.

5. The apparatus of claim 1, wherein the depth engine is configured to receive at least one of an alpha test result and a fragment shader test result, perform a depth test on each pixel, and determine whether to display the pixel, the depth test comprising comparing a current z value of each pixel against a corresponding stored z value in a buffer.

6. The apparatus of claim 1, wherein the plurality of units comprise at least two of a command engine, a triangle position and z setup unit, a rasterization engine, an attribute setup engine, a pixel interpolation engine, a texture engine and a fragment shader.

7. The apparatus of claim 1, wherein the two units comprise a rasterization engine and a fragment shader.

8. The apparatus of claim 1, wherein the fragment shader is configured to perform at least one of modify z values and discard pixels.

9. The apparatus of claim 1, further comprising switching means to receive the selection value and selectively pass data from a first unit or a second unit to the depth engine.

10. The apparatus of claim 1, wherein the apparatus is a mobile phone.

11. A machine readable storage medium storing a set of instructions comprising:
processing a graphics image using several graphics processing modules; and
selectively switching data input to a depth engine from one of two units based on a selection value.

12. The machine readable storage medium of claim 11, wherein the two units comprise a rasterization engine and a fragment shader.

13. An apparatus comprising:
a plurality of means for processing a graphics image; and
a depth testing means for receiving and processing data selected from one of two units based on a selection value.

14. The apparatus of claim 13, wherein the two units comprise a rasterization engine and a fragment shader.

15. A method comprising:
processing a graphics image using several graphics processing modules;
receiving a selection value; and
selectively switching data input to a depth engine from one of two units based on the selection value.

16. The method of claim 15, further comprising performing a stencil test on each pixel to determine whether to discard the pixel, the stencil test comprising comparing a stored stencil value for each pixel against a reference value.

17. The method of claim 15, further comprising:
receiving at least one of an alpha test result and a fragment shader test result;
performing a stencil test on each pixel; and
determining whether to display the pixel.

18. The method of claim 15, further comprising performing a depth test on each pixel to determine whether to discard the pixel, wherein the depth test comprises comparing a current z value of each pixel against a corresponding stored z value in a buffer.

19. The method of claim 15, further comprising:
receiving at least one of an alpha test result and a fragment shader test result;
performing a depth test on each pixel, wherein the depth test comprises comparing a current z value of each pixel against a corresponding stored z value in a buffer; and
based on the depth test, determining whether to display the pixel.

20. The method of claim 15, wherein the modules comprise at least two of a command engine, a triangle position and z setup unit, a rasterization engine, an attribute setup engine, a pixel interpolation engine, a texture engine and a fragment shader.

21. The method of claim 15, wherein the two units comprise a rasterization engine and a fragment shader.

22. The method of claim 15, wherein the fragment shader is configured to perform at least one of modify z values and discard pixels.
